(19) United States
(12) Patent Application Publication
(10) Pub. No.: US 2015/0135144 A1
(43) Pub. Date: May 14, 2015

(54) APPARATUS FOR OBTAINING VIRTUAL 3D OBJECT INFORMATION WITHOUT REQUIRING POINTER

(71) Applicant: VTouch Co., Ltd., Seoul (KR)

(72) Inventor: Seok-Joong Kim, Seoul (KR)

(21) Appl. No.: 14/396,384

(22) PCT Filed: Apr. 22, 2013
(86) PCT No.: PCT/KR2013/003420

§ 371 Date: Oct. 23, 2014

(30) Foreign Application Priority Data
Apr. 23, 2012 (KR) 10-2012-0042232

(51) Int. Cl. G06F 3/0481; G06F 3/00; G06F 3/03; G06F 3/01

(52) U.S. Cl. CPC G06F 3/04815; G06F 3/017; G06F 3/013; G06F 3/005; G06F 3/0321
USPC 715/850

(57) ABSTRACT

Disclosed is an apparatus for obtaining 3D virtual object information which includes a 3D coordinates calculation portion for calculating 3D coordinates data for a body of a user to extract first space coordinates and second space coordinates from the calculated 3D coordinates data, a touch location calculation portion for calculating virtual object contact point coordinates for the surface of the virtual object building on the 3D map information that is met by a line connecting the first space coordinates and the second space coordinates extracted from the 3D coordinates calculation portion; and a space location matching portion for extracting virtual object (location) belonging to the virtual object contact point coordinates data calculated from the touch location calculation portion, and providing the extracted corresponding information of the virtual object to a display portion of a user's terminal or the apparatus for obtaining the 3D virtual object information.

### TECHNICAL FIELD

The present invent ion relates to an apparatus for obtaining 3D virtual object information matched to coordinates on 3D space and in particular, to an apparatus for obtaining 3D virtual object information, using a virtual touch scheme, without requiring a pointer.

### BACKGROUND ART

The present invention starts on comparing touch panel technologies (operating without a cursor) with pointer technologies (having a cursor). The touch panel technologies have been widely used on various electronic appliances. Those touch panel technologies have an advantage of not requiring a pointer on displays comparing with the conventional pointer technologies such as mouse for PC, that is, users directly place their fingers onto icons without having to move a pointer (e.i. a mouse cursor) on screen to corresponding locations to select certain points or icons on screen. Therefore, the touch panel technologies may perform faster and more intuitive operations for controlling devices by omitting “pointer producing and moving steps” which has been required on conventional pointing technologies. The present invention is based on “a touch scheme using user's eyes and a tip of one of user's fingers” capable of remotely implementing effects (intuitive interface) of the touch panel technologies (hereinafter, called “virtual touch”), and relates to an apparatus for obtaining the 3D virtual object information using the “virtual touch scheme”.

Thanks to more advanced mobile communication technologies and IT technologies, fast mass data transmission may be performed by wired or wireless communication. Mobile communication terminals may transfer much more information in shorter amount of time, and various functions have been added. Further, improved User Interface (UI) enhanced user experiences in mobile devices further.

Further, since smart phones or tablet PCs (mobile devices) have widely been spread, various contents and applications for those mobile devices are available.

Local information services providing location information are widely used on mobile devices with numerous applications and as representative services thereof, after disposing tags over the entrances of local shops, users receive various information such as products, services and prices offered by specific stores simply by touching their mobile devices to the tags attached near the stores. Users can also grasp corresponding building or store information while traveling simply by taking a picture of the building or the signboard of the shop by matching the photo with user's current location using GPS disposed at the mobile devices.

However, on using such mobile services there are inconveniences in that users need to access close to the corresponding buildings or shops so that they can touch their phones to tags or take a picture of them.

### DISCLOSURE

### Technical Problem

An advantage of some aspects of the invention is that it provides an apparatus for obtaining 3D virtual object information, using “virtual touch” scheme, capable of obtaining virtual object information embedded in advance to the space coordinates of the object on 3d map data without having to access close to the physical object, but simply by pointing at it.

### Technical Solution

According to an aspect of the invention, there is an apparatus for obtaining 3D virtual object information without requiring a pointer, including a 3D coordinates calculation portion for calculating 3D coordinates data for a body of a user and extracting the first space coordinates and the second space coordinates from the calculated 3D coordinates of the body of the user, a touch location calculation portion for calculating virtual object contact point coordinates which is the surface of the virtual object building on the 3D map information that is met by a line connecting the first space coordinates and the second space coordinates extracted from the 3D coordinates calculation portion, by matching 3D map information and location information from GPS with the first space coordinates and the second space coordinates extracted from the 3D coordinates calculation portion, and a space location matching portion for extracting virtual object (location) belonging to the virtual object contact point coordinates data calculated from the touch location calculation portion, and providing extracted information related to the virtual object to a display portion of a user's terminal or the apparatus for obtaining the 3D virtual object information.

It is preferable that the 3D map data is stored on external servers providing 3D geographic information which are connected to wired and wireless networks.

It is preferable that the 3D map information is stored in the 3D virtual object information obtaining apparatus.

It is preferable that the 3D coordinates calculation portion calculates the 3D coordinates data by using a Time of Flight.

It is preferable that the 3D coordinates calculation portion includes an image obtaining portion, configured with at least two image sensors disposed on locations different from each other, for capturing the body of the user at angles different from each other, and a space coordinates calculation portion for calculating the 3D coordinates data for the body of the user by using the optical triangulation scheme based on the image, captured at the angles different from each other, received from the image obtaining portion.

It is preferable that the 3D coordinates calculation portion obtains the 3D coordinates data by a method of projecting coded pattern image to the user and processing the image of the scene projected with structured light.

It is preferable that the 3D coordinates calculation portion includes a lighting assembly, configured with a light source and a diffuser, for projecting speckle patterns to the body of the user, an image obtaining portion, configured with an image sensor and a lens, for capturing the speckle patterns for the body of the user projected from the lighting assembly, and a space coordinates calculation portion for calculating the 3D coordinates data for the body of the user based on the speckle patterns captured from the image obtaining portion.

It is preferable that the 3D coordinates calculation portions of at least two or more and are configured to be disposed at the locations different from each other.

It is preferable that the first space coordinates is any one of the 3D coordinates of the tip of any one of the user's fingers or the tip of the pointer grasped by the user and the second space coordinates is the 3D coordinates of the midpoint of any one of the user's eyes.

It is preferable that the first space coordinates are the 3D coordinates for the tips of at least two of the user's fingers, and the second space coordinates becomes the 3D coordinates for the midpoint of any one of the user's eyes.

### Advantageous Effects

As described above, an apparatus for obtaining 3D virtual object information without requiring a pointer in accordance with the present invention has the following effects.

First, it is possible to select goods, building and shop in 3D space remotely apart from an area disposed with a virtual touch device. Therefore, the user may remotely obtain the corresponding shop or building-related virtual object information without accessing close to the corresponding shop or building.

Second, the apparatus for obtaining the 3D virtual object information may be used at the area disposed with the virtual touch device regardless of indoor or outdoor. The area disposing the virtual touch device is shown as an indoor space in FIG. 1, but the apparatus for obtaining the 3D virtual object information in the present invention may be implemented outdoors such as an amusement park, a zoo, and a botanical garden, that is, at the area capable of disposing the virtual touch device.

Third, the present invention may be applied to an advertisement field and education field. The contents of the 3D virtual object information corresponding to the 3D coordinates of the 3D map information may become advertisement in the present invention. Therefore, it is possible to provide advertisements to the user by a method for publishing the advertisement of the corresponding shop to be corresponded to the virtual object. Further, the present invention may be applied to educational field. For example, when the user selects the relics (virtual objects), having the 3D coordinates, exhibiting at showrooms in museums disposed with the virtual touch device, it is possible to display the corresponding relics-related information (virtual object information) on the display of the user's terminal or 3D virtual object information obtaining apparatus, thereby to produce educational effect. Besides, the present invention may be applied to various fields.

### DESCRIPTION OF DRAWINGS

FIG. 1 shows configurations of an apparatus for obtaining 3D virtual object information using virtual touch according to an embodiment of the present invention;

FIG. 2 is a block diagram showing configurations of a 3D coordinates calculation portion for an optical triangulation scheme of a 3D coordinates extraction method shown in FIG. 1;

FIG. 3 is a block diagram showing configurations of the 3D coordinates calculation portion for a structured light scheme of the 3D coordinates extraction method shown in FIG. 1; and

FIG. 4 is a flow chart for describing a method for obtaining the 3D virtual object information without requiring a pointer according to the present embodiment.

### BEST MODE

Another purpose, characteristics and advantages of the present invention will be apparent by the detailed descriptions of the embodiments referencing the attached drawings.

An exemplary embodiment of an apparatus for obtaining 3D virtual object information without requiring a pointer according to the present invention is described with reference to the attached drawings as follows. Although the present invention is described by specific matters such as concrete components and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description. Therefore, the spirit of the present invention should not be limited to the above-described exemplary embodiments and the following claims as well as all modified equally or equivalently to the claims are intended to fall within the scopes and spirit of the invention.

### Mode for Invention

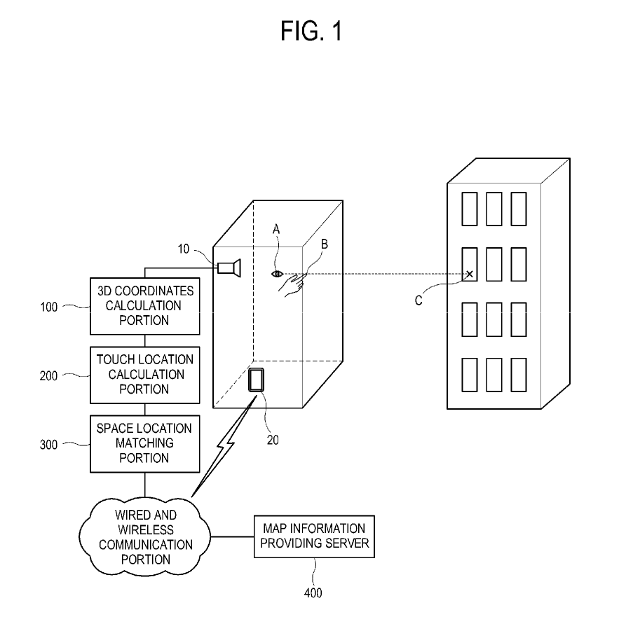

FIG. 1 shows configurations of an apparatus for obtaining the 3D virtual object information without requiring a pointer according to an embodiment of the present invention.

An apparatus for obtaining the 3D virtual object information shown in FIG. 1 includes a 3D coordinates calculation portion 100 for calculating 3D coordinates data using an image for a body of a user captured by a camera 10 and for extracting first space coordinates B and second space coordinates A from the calculated 3D coordinates data, a touch location calculation portion 200 for matching 3D map information and location information from GPS with the first space coordinates B and the second space coordinates A extracted from the 3D coordinates calculation portion 100 and calculating virtual object contact point coordinates data C for a surface of a building on the 3D map information that is met by a line connecting the first space coordinates B and the second space coordinates A and a space location matching portion 300 for extracting the virtual object (for example, an occupant in a room three-oh one of a building A) corresponding to the virtual object contact point coordinates data (C) calculated by the touch location calculation portion 200, and providing information related to the corresponding virtual object given to the extracted virtual object to a display portion (not shown) of a user's terminal 20 or the apparatus for obtaining the 3D virtual object information. That is, the user's terminal 20 is generally a mobile phone to which the user carries. The relevant information may be provided to a display portion (not shown) disposed at the apparatus for obtaining the 3D virtual object information in one embodiment of the present invention.

In addition, the present invention is embodied based on a GPS satellite, but may also be applied to a scheme providing location information by disposing a plurality of Wi-Fis at an interior space where GPS signals do not reach.

Wherein, “virtual object” may become the whole building, companies or stores located at the building, etc., but may also become articles occupying the specific space. For example, relics at museums or works at galleries as articles having pre-inputted 3D map information and GPS location information may become the virtual object. Therefore, the virtual object-related information for the relics or works pointed by the user may be provided to the user.

Further, “the virtual object-related information” is called information given to “the virtual object”. A method giving the virtual object-related information to the virtual object may be implemented by those skilled in the art, to which the present invent ion pertains, as general database-related technologies, and therefore, the description for it will be omitted. The virtual object-related information may become names, addresses and types of business of companies, and includes advertisements of the companies. Therefore, the apparatus for obtaining the 3D virtual object information in the present invention may be used as advertisement systems.

At this time, the 3D map information is provided from an external 3D map information providing server 400 connected by wired and wireless networks, or is stored into a storage portion (not shown) in the apparatus for obtaining the 3D virtual object information. Further, the storage portion (not shown) stores 3D map and virtual object-related information, image information captured by the camera, location information detected from GPS, and information for the user's terminal 20, etc.

The 3D coordinates calculation portion 100 calculates at least two space coordinates (A, B) for the body of the user using a 3D coordinates extraction method based on the image of the user captured by the camera on performing selection control remotely using the virtual touch of the user. The 3D coordinates extraction method includes an optical triangulation scheme, a structured light scheme, and a Time of Flight scheme (there are schemes duplicated from each other because correct sorting schemes are not established in relation to current 3D coordinates calculation schemes), and may be applied to any schemes or devices capable of extracting the 3D coordinates for the body of the user.

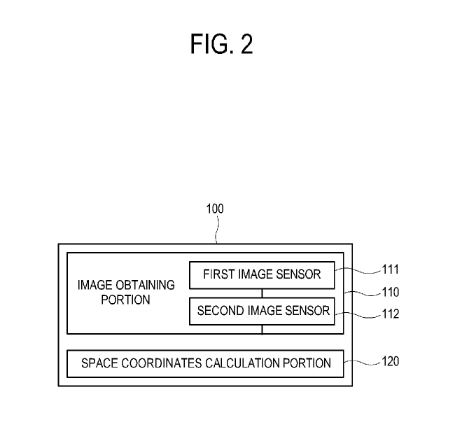

FIG. 2 is a block diagram showing configurations of a 3D coordinates calculation portion for the optical triangulation scheme of the 3D coordinates extraction method shown in FIG. 1. As shown in FIG. 2, the 3D coordinates calculation portion 100 for the optical triangulation scheme includes an image obtaining portion 110, and a space coordinates calculation portion 120.

The image obtaining portion 110, which is a kind of a camera module, includes at least two image sensors 111, 112 such as CCD or CMOS, disposed at locations different from each other, for detecting an image and converting the detected images into electrical image signals, and captures the body of the user at angles different from each other. In addition, the space coordinates calculation portion 120 calculates the 3D coordinates data for the body of the user using the optical triangulation scheme based on the image, captured at the angles different from each other, received from the image obtaining portion 110.

The optical triangulation scheme applies the optical triangulation scheme to characterizing points corresponding between the captured images to obtain 3D information. A camera self calibration technique, a corner extraction method of Harris, a SIFT technique, a RANSAC technique, a Tsai technique, etc. are adapted to various relevant techniques extracting the 3D coordinates using the triangulation.

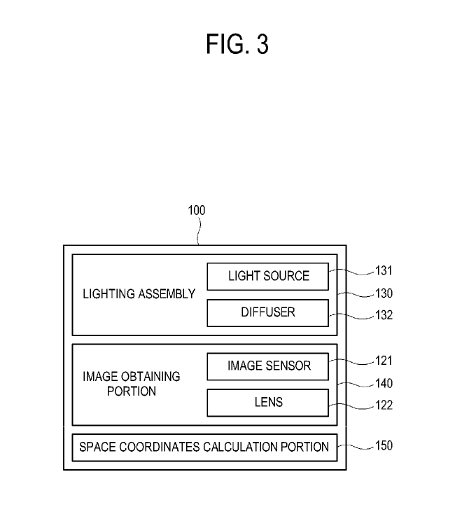

FIG. 3 is a block diagram showing configurations of the 3D coordinates calculation portion adapting the structured light scheme in another embodiment of the present invention. As shown in FIG. 3, the 3D coordinates calculation portion 100, for the structured light scheme, for obtaining the 3D coordinates data on projecting coded pattern image to the user and processing the image of a scene projected with the structured light includes a lighting assembly 130, including a light source 131 and a diffuser 132, for projecting speckle patterns to the body of the user, an image obtaining portion 140, including an image sensor 121 and a lens 122, for capturing the speckle patterns on the body of the user projected by the lighting assembly 130, and a space coordinates calculation portion 150 for calculating the 3D coordinates data for the body of the user based on the speckle patterns captured from the image obtaining portion 140. Further, a 3D coordinates data calculation method using Time of Flight (TOF) scheme may be also used in another embodiment of the present invention.

As above, the 3D coordinates data calculation methods are present in numerous ways in conventional arts and may easily be implemented by those skilled in the art to which the present invention pertains, and therefore the description for them is omitted.

On the other hand, the touch location calculation portion 200 calculates virtual object contact point coordinates data for a surface that comes into contact with a building on the 3D map information that is met by a line connecting first space coordinates and second space coordinates by using the first space coordinates (a finger) and the second space coordinates (an eye) extracted from the 3D coordinates calculation portion 100.

At this time, user's finger is used as the first space coordinates B. That is, the finger is the only human body part capable of performing exquisite and delicate operations. In particular, an exquisite pointing may be performed by using any one of a thumb or a forefinger or both together. Therefore, it is very effective to use a tips of the thumb and/or the forefinger as the first space coordinates B in the present invention. Further, in the same context, a pointer (for example, a pen tip) having a sharp tip grasped by the user may be used replacing the tip of the user's finger as the first space coordinates B.

In addition, a midpoint of one eye of the user is used as the second space coordinates. For example, when the user looks the thumb disposed at two eyes, the thumb will look as two. This is caused (by angle difference between both eyes) because shapes of the thumb, that both eyes of the user respectively look, are different from each other. However, if only one eye looks the thumb, the thumb will be clearly looked. In addition, although not closing one eye, the thumb will be markedly looked even on consciously looking only one eye. To aim with one eye closed also follows the above principle in case of game of sports such as, fire, archery, etc. requiring high accuracy on aiming.

When only one eye (the second space coordinates) looks the tip of his/her finger (the second space coordinates), the principle capable of markedly apprehending the shape of the tip of his/her finger is used in the present invention. The user should accurately look the first space coordinates, and therefore may point the virtual object contact point coordinate data for the surface contacting the building met through the 3D map information coincident with the first space coordinates.

On the other hand, when one user uses any one of his/her fingers in the present invention, the first space coordinates is any one 3D coordinates of the tip of any one of the fingers of the user or the tip of the pointer grasped by the user, and the second space coordinates become the 3D coordinates for the midpoint of any one of the user's eyes. Further, when the user uses at least two of his/her fingers, the first space coordinates are the tips of at least two of his/her fingers.

In addition, the touch location calculation portion 200 calculates the virtual object contact point coordinates for the surface of the virtual object met by a line connecting the first space coordinates and the second space coordinates on the 3D map information when the virtual object contact point coordinate data are not varied from time calculated by initial virtual object contact point coordinate data to the set time.

Further, the touch location calculation portion 200 determines whether the virtual object contact point coordinate data are varied from time calculated by the initial virtual object contact point coordinate data to the set time, determines whether distance variation above the set distance between the first space coordinates and second space coordinates is generated when the virtual object contact point coordinate data are not varied above the set time, and calculates the virtual object contact point coordinate data for the surface contacting the building met through the 3D map information when the distance variation above the set distance is generated.

On the other hand, when it is determined that the virtual object contact point coordinate data are varied within the set range, it may be regarded that the virtual object contact point coordinate data are not varied. That is, when the user points by the tip of his/her finger or pointer, there are some movements or tremors of his/her body or finger due to physical characteristics and therefore it is very difficult to maintain the contact coordinate by the user. Therefore, it is regarded that the virtual object contact point coordinate data are not varied when the virtual object contact point coordinate data values are within the predefined set range.

Operations for the apparatus for obtaining the 3D object information, according to the present invention, configured as above are described with reference to the attached drawings. Like reference numeral in FIG. 1 to FIG. 3 refers to like members performing the same functions.

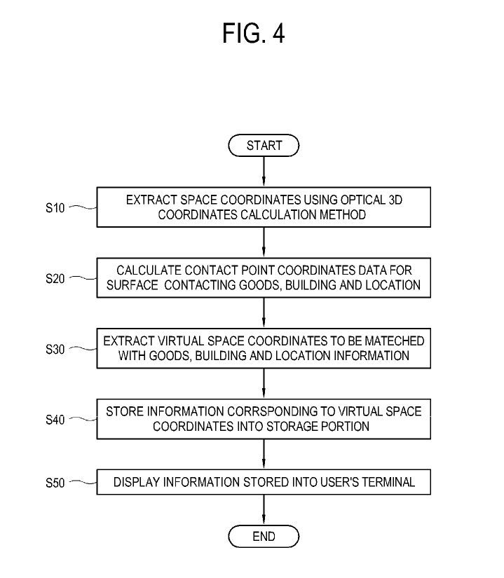

FIG. 4 is a flow chart for describing a method for obtaining the 3D virtual object information according to the present embodiment.

Referring to FIG. 4, when the user performs selecting operations by remotely using the virtual touch, the 3D coordinates calculation portion 100 uses image information captured by the camera and therefore extracts at least two space coordinates for the body of the user, respectively. The 3D coordinates data use the 3D coordinates calculation method (the optical triangulation scheme, the structured light scheme, Time of Flight (TOF), etc.), calculates the first space coordinates and the second space coordinates based on the 3D space coordinates for the body of the user, and extracts the line connecting the calculated the first space coordinate and the second space coordinate (S10). It is preferable that the first space coordinates is any one of the 3D coordinates of the tip of any one of the user's fingers or the tip of the pointer grasped by the user, and the second space coordinates is the 3D coordinates for the midpoint of any of the user's eyes.

In addition, the touch location calculation portion 200 receives the current location information received from the GPS and the 3D map information received, tri⁻dimensionally provided with the building or location, etc., from the 3D map information providing server 400, and stores it into a storage portion 310. In addition, it combines the location information and 3D map information stored into the storage portion 310 with at least two space coordinates (A, B) extracted from the 3D coordinates calculation portion 100, calculates the contact point coordinates for the surface of the object (C) that is met by a line connecting the space coordinates (A, B) (S20). The definition of the contact point coordinates can be set by the user, but it is preferable to be defined as the firstly met object (location).

On the other hand, a method for calculating the contact point coordinates for the surface of the object (C) that is met by a line connecting the space coordinates (A, B) (S20) includes an absolute coordinate method, a relative coordinate method and an operator selection method.

The absolute coordinate method calculates back time matching the 3D map information and the projected scenes and obtains an absolute coordinate at the space coordinate. That is, this method defines a target to be matched with a camera scene by location data having various obtainable courses such as a GPS, a gyro sensor, a compass or base station information, etc. and may obtain fast result.

The relative coordinate method is that the camera having the absolute coordinate fixed at the space converts from the relative coordinate of the operator to the absolute coordinate. That is, this method is corresponded to a space type when the camera having the absolute coordinates reads hands and eyes, wherein a technology is that one point becoming an absolute coordinate is provided by the space type.

The operator selection method displays selection menus having the corresponding range based on obtainable information like the current smartphone AR services, displays the selection menus capable of including an error range without a correct absolute coordinate through a selection type performed by the user and then selects them, and excludes the error by the user, thereby to obtain the result.

The surface being in contact with the space coordinates A and B is defined to the building or location by the 3D map information in the present invention, but this is only a desirable embodiment and may be defined as works such as works of art or collectibles when the stored 3D map information is defined to the specific regions such as museums or art galleries

The space location matching portion 300 extracts the virtual object (location) that belongs to the calculated virtual object contact point data (S30), detects the virtual object-related information such as the extracted virtual object-related building names, lot numbers, shop names, ad sentences, service sentences, links(capable of moving into another network or site), and stores them (S40).

In addition, the space location matching portion 300 transmits the virtual object-related information such as the stored and extracted virtual object-related building names, lot numbers, shop names, ad sentences, service sentences, etc. to a display portion of the user's terminal 20 or the apparatus for obtaining the virtual object information, and displays them (S50).

Although the spirit of the present invention was described in detail with reference to the preferred embodiments, it should be understood that the preferred embodiments are provided to explain, but do not limit the spirit of the present invention. Also, it is to be understood that various changes and modifications within the technical scope of the present invention are made by a person having ordinary skill in the art to which this invention pertains.

### INDUSTRIAL APPLICABILITY

The present invention is an apparatus for obtaining 3D virtual object information, using a virtual touch scheme, without requiring a pointer.

1. An apparatus for obtaining 3D virtual object information without requiring a pointer, comprising:
a 3D coordinates calculation portion for calculating 3D coordinates data for a body of a user to extract first space coordinates and second space coordinates from the calculated 3D coordinates data;
a touch location calculation portion for calculating virtual object contact point coordinates for the surface of the virtual object building on the 3D map information that is met by a line connecting the first space coordinates and the second space coordinates extracted from the 3D coordinates calculation portion, by matching 3D map information and location information from GPS with the first space coordinates and the second space coordinates extracted from the 3D coordinates calculation portion; and
a space location matching portion for extracting virtual object (location) belonging to the virtual object contact point coordinates data calculated from the touch location calculation portion, and providing the extracted corresponding information of the virtual object to a display portion of a user's terminal or the apparatus for obtaining the 3D virtual object information.

2. The apparatus for obtaining the 3D virtual object information without requiring a pointer according to claim 1, wherein the 3D map information is stored on external servers providing 3D geographic information which are connected to wired or wireless networks.

3. The apparatus for obtaining the 3D virtual object information without requiring a pointer according to claim 1, wherein the 3D map information is stored in the 3D virtual object information obtaining apparatus.

4. The apparatus for obtaining the 3D virtual object information without requiring a pointer according to claim 1, wherein the 3D coordinate calculation portion calculates the 3D coordinates data by using a Time of Flight.

5. The apparatus for obtaining the 3D virtual object information without requiring a pointer according to claim 1, wherein the 3D coordinates calculation portion includes an image obtaining portion, configured with at least two image sensors disposed at locations different from each other, for capturing the body of the user at angles different from each other; and a space coordinates calculation portion for calculating the 3D coordinate data for the body of the user using the optical triangulation scheme based on the image, captured at the angles different from each other, received from the image obtaining portion.

6. The apparatus for obtaining the 3D virtual object information without requiring a pointer according to claim 1, wherein the 3D coordinates calculation portion obtains the 3D coordinates data by a method for projecting coded pattern images to the user and processing images of the scene projected with structured light.

7. The apparatus for obtaining the 3D virtual object information without requiring a pointer according to claim 6, wherein the 3D coordinates calculation portion includes alighting assembly, configured with alight source and a diffuser, for projecting speckle patterns to the body of the user, an image obtaining port ion, configured with an image sensor and a lens, for capturing the speckle patterns for the body of the user projected from the lighting assembly, and a space coordinate calculation portion for calculating the 3D coordinates data for the body of the user based on the speckle patterns captured from the image obtaining portion.

8. The apparatus for obtaining the 3D virtual object information without requiring a pointer according to claim 6, wherein the 3D coordinates calculation portions are at least two or more and are configured to be disposed at the locations different from each other.

9. The apparatus for obtaining the 3D virtual object information without requiring a pointer according to claim 1, wherein the first space coordinates is any one of the 3D coordinates of the tip of any one of the user's fingers or the tip of the pointer grasped by the user and the second space coordinates is the 3D coordinates for the midpoint of any one of the user's eyes.

10. The apparatus for obtaining the 3D virtual object information without requiring a pointer according to claim 1, wherein the first space coordinates are the 3D coordinates for the tips of at least two of the user's fingers, and the second space coordinates is the 3D coordinates for the midpoint of any one of the user's eyes.
